(19) United States
(12) Patent Application Publication
(10) Pub. No.: US 2021/0165422 A1
(43) Pub. Date: Jun. 3, 2021

(54) DRIVERLESS VEHICLE PRIORITY SYSTEM

(71) Applicant: CoKo Tech, LLC, Albuquerque, NM (US)

(72) Inventors: Christine Koski, Dallas, TX (US); Stephen Charles Cook, Albuquerque, NM (US)

(21) Appl. No.: 16/701,599

(22) Filed: Dec. 3, 2019

(51) Int. Cl. G05D 1/02; G06Q 50/30; G05D 1/00

(52) U.S. Cl. CPC G05D 1/0287; G05D 2201/0213; G05D 1/0088; G06Q 50/30

(57) ABSTRACT

In a method for managing a vehicle priority system, a priority engine determining relative priorities of the first and second vehicles. The priority engine instructs operation of the first and second vehicles according to their relative priorities. The priority engine received payment to modify the relative priorities of the first and second vehicles and instructs operation of the first and second vehicles accordingly.

### FIELD OF THE INVENTION

The field of the invention is vehicle management systems.

### BACKGROUND

Given the increase in driver-independent vehicle aids being implemented in vehicles and driverless vehicles being developed and used in real world circumstances, establishing communication between or among vehicles is vital in creating a robust system that can accommodate to changing variables. Importantly, establishing communication between or among vehicles such that the one or more vehicles in communication change their respective behaviors based on the vehicles around them greatly enhances, broadens, and deepens the utility of driverless vehicles.

In conventional systems, vehicles simply react to their surroundings and rely on human intervention to cause changes in driving behavior that fit with the vehicle operator's priorities. For example, conventional cars can have a multitude of sensors, including, for example, distance sensors, light sensors, and any other sensors that allow conventional cars to react to various situational changes. These conventional sensors are limited to reacting defensively to keep vehicles in their lane, to automatically brake in response to slow downs, and various other reactive measures. However, conventional sensors are bound by the vehicle operator's actions.

In contrast, self-driving vehicles can autonomously make decisions to directly control vehicle movement without user input. Where self-driving vehicles can communicate with external entities, establishing a hierarchy of vehicles based on their respective permissions allows for a great degree of flexibility in controlling the driving behaviors of multiple vehicles. For example, establishing different tiers of cruising speeds on a highway assigned to particular lanes based on user preferences and instructing each vehicle to stay in their respective cruising speed category is possible if inter-vehicle communication and control are implemented. In another example, establishing heightened permissions for emergency vehicles can automatically cause non-prioritized vehicles to move to the side of the road when emergency vehicles are present.

US Patent Application Publication Number WO2014148975 to Andersson teaches a system that prioritizes various vehicles based on the work assignments they are required to perform. Additionally, Andersson requires the use of predetermined rules on how to prioritize different vehicles. As such, Syswerda is limited in its application and does not contemplate the dynamic creation of rules based on changing priorities and situational factors.

US Patent Application Publication Number 2017/0192438 to Morimoto teaches a vehicle control system for intersection management. Morimoto discloses that vehicles approaching each other in opposing directions will change their trajectories based on a travel priority. Morimoto fails to focus on changing rules in response to changing vehicle priorities and situational factors. Additionally, Morimoto limits the use to oncoming vehicles where the vehicles' routes opposite each other and only uses a travel priority to determine whether to alter vehicle routes.

Andersson, Morimoto, and all other extrinsic materials discussed herein are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for systems to allow driverless vehicles to automatically detect and react to a multitude of variables by dynamically creating or changing rules controlling vehicle behavior.

### SUMMARY OF THE INVENTION

Where self-driving vehicles can communicate with external entities, establishing a hierarchy of vehicles based on their respective permissions allows simultaneous controlling of multiple vehicles with a great degree of flexibility. For example, establishing different tiers of cruising speeds on a highway assigned to particular lanes based on user preferences and instructing each vehicle to stay in their respective cruising speed category is possible if inter-vehicle communication and control are implemented.

A vehicle management system allows vehicle priority to be established among multiple vehicles within threshold proximity.

Among other things, the inventive subject matter provides apparatus, systems, and methods in which a vehicle management system identifies vehicles within designated parameters and establishes communications between or among multiple vehicles. Once communication is established, the inventive subject matter determines the priority of a designated vehicle relative to the surrounding vehicles. Based on the priority established, the vehicle management system communicates one or more instructions to the designated vehicle to cause executing of the one or more instructions.

Various resources, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a method identifying vehicles priorities and determining priority parameters in a multi-vehicle system.

FIG. 2 is a schematic of a method of dynamically adjusting priority parameters based on one or more changes in priority.

### DETAILED DESCRIPTION

It should be noted that while the following description is drawn to a computer-based scheduling system, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including facilitating the movement of driverless and non-driverless vehicles, establishing priorities/precedence among multiple vehicles, and allowing communication between or among vehicles.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

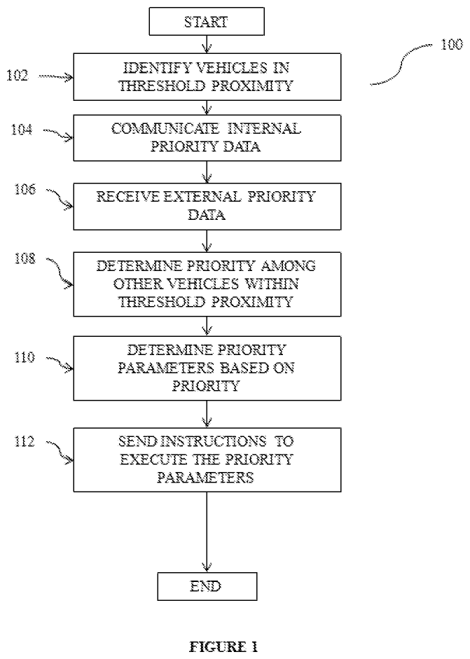

FIG. 1 is a schematic of a method identifying vehicles priorities and determining priority parameters in a multi-vehicle system.

Priority engine 100 identifies one or more vehicles within a threshold proximity (step 102).

As defined herein, a vehicle refers to any mode of transportation. For example, vehicles can include automobiles, planes, boats, and trains. It is contemplated that vehicles can also include driverless vehicles, conventional vehicles, and any combination of driverless and conventional vehicles (e.g., a conventional vehicle guiding a group of self-driving vehicles).

The threshold proximity can be set at any distance away from one or more points. In some embodiments, the threshold proximity can be greater than the maximum distance between one vehicle and another. For example, the threshold proximity can be set to include every vehicle in the world. In preferable embodiments, the threshold proximity is set to a distance to include vehicles within a proximity that meaningfully affects the flow of traffic around a designated vehicle. For example, the threshold proximity can be set to a 2000 feet radius around a car.

It is also contemplated that the threshold proximity can additionally or alternatively include non-distance based variables. For example, the threshold proximity can include a designated geographical area, a common destination between or among multiple vehicles, and any other variable that allow priority engine 100 to establish priorities among one or more vehicles or groups of vehicles.

Preferably, priority engine 100 uses global positioning systems (GPS) to identify vehicles within a threshold proximity to a designated vehicle and/or geographical area. In some embodiments, the tracking is performed by an external entity. For example, priority engine 100 can use satellite imaging to determine the positions of multiple vehicles and then communicate the information to one or more vehicles. It is contemplated that the aforementioned type of tracking is advantageous in environments where routes are not clearly established and/or where inter-vehicle communication is difficult, including, for example, undeveloped, mountainous regions.

It is further contemplated that priority engine 100 can use any other spatial tracking system to determine the location of vehicles within a threshold proximity. For example, priority engine 100 can use altitude data when determining routes and spatial positioning of airplanes. In another example, priority engine 100 can use depth data when determining the spatial positioning of submarines.

In preferred embodiments, global positioning coordinates of multiple vehicles are gathered, consolidated, and used to identify vehicles within the threshold proximity. For example, global positioning coordinates of each vehicle in a city can be communicated to each other using conventional cellular data networks, gathered, and used to determine vehicles falling within a threshold proximity of a point of interest. It is also contemplated that any transmittable data can be communicated between or among vehicles, such as, for example, priority data and payment information.

In some embodiments, priority engine 100 identifies vehicles based on parameters. For example, priority engine 100 can isolate the commercial trucks within a threshold proximity rather than every category of vehicle when determining priority in weigh station for commercial vehicles.

Priority engine 100 communicates internal priority data (step 104).

Internal priority data comprises any data associated with the priority of a designated vehicle. For example, the designated vehicle can be a user's car. It is contemplated that the designated vehicle serves as the basis for data gathered and calculations executed by priority engine 100. For example, a user's car can serve as a geographical location that is used to determine which vehicles are in a threshold proximity to the user's vehicle.

Internal priority data can be communicated through any communications medium known in the art. For example, priority data, geographical location, type of vehicle, and speed can be communicated to from the designated vehicle to other vehicles through one or more wireless transmission mediums, including, for example, a cellular data network, satellite-based communication, and/or near field communications.

It is also contemplated that the vehicles are interconnected and receive data outside of their communications range by using a daisy-chain data transmission structure from vehicle to vehicle. For example, a vehicle can communicate and receive internal priority data from a vehicle falling outside one-mile range limit of a near field communications device by sending or receiving internal priority data between six cars that bridge a five-mile gap in increments of approximately one mile.

In some embodiments, one or more of the vehicles are connected by proxy of other devices. For example, a smart phone connected by near field communications to the vehicle can handle intervehicle communication using a cellular data network.

It is contemplated that vehicles can communicate directly with each other and/or through a central communication hub (e.g., a third-party service).

Priority engine 100 receives external priority data (step 106).

External priority data can comprise any data associated with factors outside of the designated vehicle. For example, external priority data can comprise data about every other vehicle within a threshold proximity of the designated vehicle. In another example, external priority data can include information received from third party services, including, for example, GPS services and emergency notification services.

As with internal priority data, external priority data can be communicated through any communications medium known in the art. For example, priority data, geographical location, type of vehicle, and speed can be communicated from other vehicles to the designated vehicle through one or more wireless transmission mediums, including, for example, a cellular data network, satellite-based communication, and/or near field communications.

Priority engine 100 determines the priority of the designated vehicle among the other vehicles within the threshold proximity (step 108).

Priority engine 100 can utilize any available information to determine the priority of the designated vehicle relative to the other vehicles falling within the threshold proximity. For example, information can comprise one or more of: (1) vehicle routes, (2) vehicle speeds, (3) vehicle classifications, (4) internal priority data, (5) external priority data, (6) environmental data, and (7) driver data.

It is contemplated that priority engine 100 can use any type of analysis to determine the priority of one or more designated vehicles. For example, priority engine 100 can use mathematical optimization techniques, including, for example, heuristics/metaheuristics, constraint satisfaction, space mapping, combinatorial optimization, non-linear programming, disjunctive programming, and multi-objective optimization. However, priority engine 100 is not limited to any one or more optimization techniques, and can employ any optimization technique known in the art.

Priority engine 100 determines priority parameters for a designated vehicle based on the determined priority (step 110).

Priority parameters comprise any parameters that directly or indirectly control one or more vehicles based on their determined priorities, respectively.

In one embodiment, priority engine 100 selects a travel speed, travelling lane, a route, and a target travel time for a designated vehicle. For example, where the designated vehicle is an ambulance responding to child with moderate injuries, priority engine 100 can determine that the ambulance will travel at a minimum of 35 miles per hour, have access to all prioritized lanes (e.g. carpool lanes), travel the shortest route between the ambulance and the destination, and arrive at the destination before 5 minutes elapses. In another example, priority engine 100 can determine that a vehicle that paid a priority fee can travel an average of 10 miles per hour faster than non-prioritized traffic, have access to a toll lane, and travel the shortest route that does not interfere with emergency vehicles.

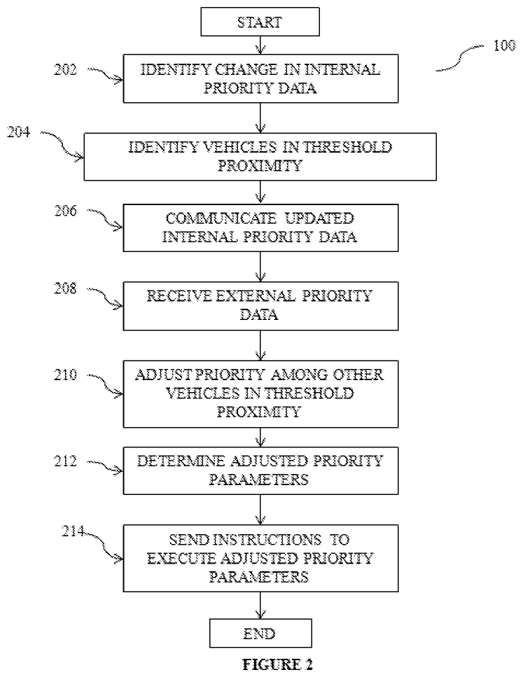

It is also contemplated that priority engine 100 can dynamically reassess priority data and determine priority parameters based on changing variables, which is discussed in more detail in FIG. 2. In the previous example, priority engine 100 can remove the access to all prioritized lanes upon receiving external priority data indicating a higher priority emergency occurring along the same route at the same time, such as, for example, a ten-vehicle car accident.

Priority engine 100 sends instructions to execute the priority parameters (step 112).

It is contemplated that priority engine 100 can send instructions to notify a user regarding the priority parameters and/or directly control one or more functions of the vehicles to comply with the determined priority parameters.

For example, priority engine 100 can send instructions to notify a user that access to a priority lane on the highway has been granted, and also directly update the GPS coordinates in the vehicle to update the indicated route. In another example, priority engine 100 can send program instructions to directly control a vehicle.

FIG. 2 is a schematic of a method of dynamically adjusting priority parameters based on one or more changes in priority.

Priority engine 100 identifies a change in internal priority data (step 202).

Preferably, priority engine 100 automatically detects one or more changes in the internal priority data. In some embodiments, priority engine 100 receives changes in priority data when a user decides to send the data.

Changes in internal priority data can include, but are not limited to, situational changes, user-initiated changes, and vehicular changes. For example, a vehicle can lose priority if an ambulance having a higher priority status is travelling on the same route within a threshold proximity. In another example, the user may decide to deactivate a priority status by opting out of paying a fee. In yet another example, a vehicle can lose priority when priority engine 100 detects a mechanical issue with the vehicle that prevents the vehicle from safely travelling on a highway.

Priority engine 100 identifies one or more vehicles within a threshold proximity (step 204).

As similarly discussed in step 102, priority engine 100 preferably uses global positioning systems (GPS) to identify vehicles within a threshold proximity to a designated vehicle and/or geographical area. In some embodiments, the tracking is performed by an external entity. However, it is contemplated that priority engine 100 can use any method of identifying vehicles within a threshold proximity known in the art.

In preferred embodiments, global positioning coordinates of multiple vehicles are gathered, consolidated, and used to identify vehicles within the threshold proximity. For example, global positioning coordinates of each vehicle in a city can be communicated to each other using conventional cellular data networks, gathered, and used to determine vehicles falling within a threshold proximity of a point of interest. It is also contemplated that any transmittable data can be communicated between or among vehicles, such as, for example, priority data and payment information.

It is contemplated that priority engine 100 uses the location of one or more designated vehicles to establish a center point and the outer boundaries of the threshold proximity. In embodiments where multiple vehicles are used to establish the center point, priority engine 100 selects a center point that best represents the multiple vehicles. For example, priority engine 100 can average the distances between three cars to determine a center point that falls in between each of the vehicles.

Priority engine 100 communicates updated internal priority data (step 206).

Internal priority data can be communicated through any communications medium known in the art. For example, priority data, geographical location, type of vehicle, and speed can be communicated to from the designated vehicle to other vehicles through one or more wireless transmission mediums, including, for example, a cellular data network, satellite-based communication, and/or near field communications.

It is also contemplated that the vehicles are interconnected and receive data outside of their communications range by using a daisy-chain data transmission structure, in which data is transmitted from vehicle to vehicle. For example, a vehicle can communicate and receive internal priority data from a vehicle falling outside one-mile range limit of a near field communications device by sending or receiving internal priority data between six cars that bridge a five-mile gap in increments of approximately one mile.

Using a daisy-chain data transmission structure is especially advantageous in situations where conventional wireless communications mediums are impractical or not possible. The daisy-chain transmission structure is not limited to a linear progression. For example, the daisy chain transmission structure can resemble a web where data is transmitted between more than two vehicles at a time.

In some embodiments, one or more of the vehicles are connected by proxy of independent wireless devices. For example, a smart phone connected by near field communications to the vehicle can handle intervehicle communication using a cellular data network.

Priority engine 100 receives external priority data (step 208).

As similarly discussed in step 106, external priority data can be communicated through any communications medium known in the art. It is contemplated that the external priority data can include all, part, or none of the external priority data collected in a prior instance.

In a closed system, the external priority data can comprise the data from the same group of vehicles. For example, priority engine 100 can receive the external priority data from maintenance vehicles for a closed business campus.

In a partially open system, the external priority data can comprise data from a pre-designated group as well as a variable group of vehicles. For example, priority engine 100 can receive the external priority data from a non-variable group of maintenance vehicles and a variable group of customer vehicles driving on the business campus.

In an open system, the external priority data can comprise data from a variable group of vehicles. For example, priority engine 100 can receive the external priority data from a highly-variable group of vehicles surrounding a designated vehicle on a public highway.

Priority engine 100 adjusts the priority of the designated vehicle among the other vehicles within the threshold proximity (step 210).

As discussed similarly in step 108, priority engine 100 can utilize any available information to adjust the priority of the designated vehicle relative to the other vehicles falling within the threshold proximity. It is also contemplated that priority engine 100 can use any type of analysis to adjust the priority of one or more designated vehicles.

Priority engine 100 determines adjusted priority parameters (step 212).

It is contemplated that priority engine 100 can alter preexisting priority parameters and create new priority parameters depending on situation. Where the situation within the threshold proximity remains substantially similar or the same, priority engine 100 can make one or more adjustments to the previously determined priority parameters. For example, priority engine 100 can allow the top speed of a designated vehicle 10 miles per hour faster in response to a reduction in traffic and corresponding increase in average travel speed.

Additionally, priority engine 100 can create new priority parameters based on a change in the situation that requires a new priority parameter. For example, priority engine 100 can create a new priority parameter that allows a designated vehicle to travel in a priority lane that became available after the initial priority parameters were determined.

However, it is contemplated that priority engine 100 can change any variable associated with the behavior of the designated vehicle in response to any changes in travel conditions.

Priority engine 100 sends instructions to execute the adjusted priority parameters (step 214).

Preferably, priority engine 100 sends instruction to execute the adjusted priority parameters wirelessly to a designated vehicle. For example, priority engine 100 can use a conventional cellular data network, a wireless fidelity-based network, a satellite transmission medium, and/or a radio transceiver-based system.

It is contemplated, however, that priority engine 100 can use any communications medium known in the art.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something designated from the group consisting of A, B, C . . . and N, the text should be interpreted as requiring only one element from the group, not A plus N, or B plus N, etc.

What is claimed is:

1. A method for managing operation of first and second vehicles, comprising in sequence using an electronic system to automatically:
determining relative priorities of the first and second vehicles;
instructing operation of the first and second vehicles according to their relative priorities;
receiving payment to modify relative priorities of the first and second vehicles; and
instructing operation of the first and second vehicles according to the modified relative priorities.

2. The method of claim 1, wherein the first set of priority data comprises data used to determine one or more priority parameters associated with the second vehicle.

3. The method of claim 2, wherein the second set of priority data comprises data used to determine one or more priority parameters associated with the first set of vehicles.

4. The method of claim 1, wherein the priority parameter is selected from the group consisting of: a travel speed, a travelling lane, a route, and a target travel time.

5. The method of claim 1, further comprising:
identifying a change in relative priorities of the first and second vehicles;
adjusting travel characteristics of the first and second vehicles in response to the change in relative priorities of the first and second vehicles; and
executing a modified operation of the first and second vehicles according to the adjusted travel characteristics.

6. The method of claim 5, wherein the first set of vehicles and the second set of vehicles overlap.

7. The method of claim 5, wherein the priority parameter is selected from the group consisting of: a travel speed, a travelling lane, a route, and a target travel time.

8. The method of claim 1, wherein the priority parameters are determined based on a paid monetary amount.

9. The method of claim 1, wherein the first and second vehicles are selected from a group consisting of: autonomous vehicles, partially autonomous vehicles, and non-autonomous vehicles.

10. The method of claim 1, wherein the payment is selected from the group consisting of: currency, travel position, travel speed, and travel route.

11. The method of claim 1, wherein instructing operation of the first and second vehicle, further comprises causing the first and the second vehicle to change driving characteristics in response to a travel restriction.

12. The method of claim 11, wherein the travel restriction is selected from the group consisting of: a road closure, a presence of an emergency vehicle, and a change in lane priority designation.
